(19) United States
(12) Patent Application Publication
(10) Pub. No.: US 2026/0254863 A1
(43) Pub. Date: Aug. 27, 2026

(54) A METHOD AND APPARATUS FOR NEGOTIATION OF CONVERSATIONAL IMMERSIVE AUDIO SESSION

(71) Applicant: Nokia Technologies Oy, Espoo (FI)

(72) Inventors: Sujeet Shyamsundar Mate, Tampere (FI); Lasse Juhani Laaksonen, Tampere (FI); Lauros Pajunen, Helsinki (FI); Tapani Pihlajakuja, Kellokoski (FI)

(21) Appl. No.: 19/160,072

(22) PCT Filed: Feb. 1, 2024
(86) PCT No.: PCT/EP2024/052493

§ 371 Date: Aug. 27, 2025

Related U.S. Application Data
(60) Provisional application No. 63/448,433, filed on Feb. 27, 2023.

(51) Int. Cl. H04L 65/1104; H04L 65/75; H04L 69/24

(52) U.S. Cl. CPC H04L 65/1104; H04L 65/75; H04L 69/24

(57) ABSTRACT

Negotiation of a conversational immersive audio session includes obtaining one or more supported immersive conversational codec input formats, providing the one or more immersive conversational codec input formats in an order as a list, including an immersive conversational codec input format attribute in a session description file, populating the input format attribute with the list of immersive conversational codec input formats in the session description file, generating a session negotiation offer, based on the session description file, and transmitting the session negotiation offer to a receiver user equipment.

### TECHNICAL FIELD

The examples and non-limiting embodiments relate generally to multimedia transport and, more particularly, to a method and apparatus for negotiation of a conversational immersive audio session.

### BACKGROUND

It is known to perform data compression and decoding in a multimedia system.

### BRIEF DESCRIPTION OF THE DRAWINGS

The foregoing aspects and other features are explained in the following description, taken in connection with the accompanying drawings, wherein:

FIG. 1 is a block diagram of one possible and non-limiting system in which the example embodiments may be practiced.

FIG. 2 is an example apparatus configured to implement the examples described herein.

FIG. 3 shows a representation of an example of non-volatile memory media used to store instructions that implement the examples described herein.

FIG. 4 is an example method of a sending apparatus, based on the examples described herein.

FIG. 5 is an example method of a receiving apparatus, based on the examples described herein.

FIG. 6 shows an example of a conversational immersive audio session between two participants.

### DETAILED DESCRIPTION OF EXAMPLE EMBODIMENTS

Described herein is a method and apparatus for negotiation of a conversational immersive audio session.

### 3GPP IVAS Input Formats

The immersive voice and audio services (IVAS) codec is an extension of the 3GPP EVS codec and intended for new immersive voice and audio services over 4G/5G. Such immersive services include, e.g., immersive voice and audio for virtual reality (VR). The multi-purpose audio codec is expected to handle the encoding, decoding and rendering of speech, music and generic audio. It is expected to support a variety of input formats, such as channel-based and scene-based inputs. It is also expected to operate with low latency to enable conversational services as well as support high error robustness under various transmission conditions. The IVAS codec standardization is currently expected to be completed in 2023 as part of Release 18.

The supported input formats for IVAS are stereo, multichannel, object-based audio, scene-based audio, and MASA. In addition, some combinations can be supported by various means, e.g., Objects with MASA (OMASA) combined format has been proposed. In addition, a separate input format exists for binaural audio, which currently operates the same as stereo input. For mono inputs, the 3GPP EVS codec is used. For detailed algorithm description of EVS, see TS 26.445.

Stereo input refers to audio representation, where two channels of audio are assigned to the left and right audio channels.

Multichannel (MC) input refers to audio representation, where each transported channel represents an audio signal for a loudspeaker surrounding the listener. IVAS supports surround formats 5.1 and 7.1 and surround formats with elevated speaker positions 5.1.2, 5.1.4 and 7.1.4.

Object-based audio, or Independent Streams with Metadata (ISM), input refers to audio representation, where individual mono audio object streams are transmitted. In addition to the transported audio, metadata describing the audio objects is transmitted, which is expected to be azimuth and elevation of the audio object (ISM).

Scene-based audio (SBA) input refers to Ambisonics-based audio representation. Ambisonics signals carry a representation of the audio scene, where the transport channels refer to capturing directions in a spherical domain. The first channel (W) represents the omnidirectional capture, the incoming sound field from all directions. The next three channels (X, Y, Z) represent the incoming sound from the according spatial axes. These four channels form the first order Ambisonics (FOA) representation. A higher spatial accuracy can be achieved by increasing the number of capturing directions with more channels. This increases the order of the Ambisonics representation, referred to as higher order Ambisonics (HOA). Second order Ambisonics (HOA2) includes 9 channels, and third order (HOA3) includes 16 channels. IVAS supports first, second and third order Ambisonics.

MASA refers to a parametric spatial audio representation called metadata-assisted spatial audio and defined for IVAS in Permanent Document IVAS-4 (Tdoc S4-221619). It uses audio signal(s) together with corresponding spatial metadata (containing, e.g., directions and direct-to-total energy ratios in frequency bands). The MASA stream can, e.g., be obtained by capturing spatial audio with microphones of, e.g., a mobile device, where the set of spatial metadata is estimated based on the microphone signals. The MASA stream can be obtained also from other sources, such as specific spatial audio microphones (such as Ambisonics), studio mixes (e.g., 5.1 mix) or other content by means of a suitable format conversion. It is also possible to use MASA tools inside a codec for the encoding of multichannel channel signals by converting the multichannel signals to a MASA stream and encoding that stream.

OMASA refers to MASA with additional object-based audio (1-4 objects). The object-based audio streams are provided to an encoder as separate streams from the MASA stream. OMASA is being proposed to be part of IVAS, but it is not yet formally part of the IVAS Codec Baseline.

### IVAS Bitrates

The currently supported bitrates for each IVAS input format are presented in Table 1. The current continuous bitrate ranges for IVAS input modes are presented in Table 2. Notably SBA, MC, MASA and OMASA input modes are supported for a wide continuous bitrate range from 13.2 kbps (kilobits per second) to 512 kbps. Stereo input mode is supported up to 256 kbps. The supported bitrate ranges for ISM depend on the number of objects. ISM input mode is supported up to 128 kbps (1 object), 256 kbps (2 objects), 384 kbps (3 objects) and 512 kbps (4 objects). (The exact values are subject to change until the standard is completed. Also, OMASA is currently being proposed and not yet formally part of the IVAS Codec Baseline).

Table 1 shows supported input modes for IVAS and the supported bitrates for each mode.

TABLE 1

| Mode | Supported bitrates in kbps |
|---|---|
| ISM (1 object) | 13.2, 16.4, 24.4, 32, 48, 64, 80, 96, 128 |
| Stereo, ISM (2 objects) | 13.2, 16.4, 24.4, 32, 48, 64, 80, 96, 128, |
| | 160, 192, 256 |
| ISM (3 objects) | 13.2, 16.4, 24.4, 32, 48, 64, 80, 96, 128, |
| | 160, 192, 256, 384 |
| SBA, MC, MASA, | 13.2, 16.4, 24.4, 32, 48, 64, 80, 96, 128, |
| OMASA, ISM (4 objects) | 160, 192, 256, 384, 512 |

Table 2 shows supported IVAS input modes for continuous bitrate ranges.

TABLE 2

| Mode | Supported bitrates in kbps |
|---|---|
| ISM (1 object) | 13.2-128 |
| Stereo, ISM (2 objects) | 13.2-256 |
| ISM (3 objects) | 13.2-384 |
| SBA, MC, MASA, OMASA, | 13.2-512 |
| ISM (4 objects) | |

### IVAS Output Formats

The IVAS output formats for IVAS include mono, stereo, multi-channel (including custom loudspeaker layouts), FOA, HOA2, HOA3, and binaural. In addition, so-called pass-through operation is available allowing, e.g., MASA output for MASA input. Binauralized audio can utilize default or custom HRIRs and room effects (BRIRs). Multi-channel output refers to rendering, where multiple audio channels are rendered for a playback system (e.g., surround loudspeaker setups 5.1, 7.1, 5.1.2, 5.1.4 or 7.1.4).

Scene based audio output rendering (FOA, HOA2, HOA3) refers to rendering, where the input stream is decoded and rendered into the corresponding Ambisonics channels.

Binaural rendering renders the output binaurally to the receiver through headphones. Binaural room output mode applies a room impulse response to the output signal.

### RTP—Real-Time Transport Protocol

RTP is intended for an end-to-end, real-time transfer of streaming media and provides facilities for jitter compensation and detection of packet loss and out-of-order delivery. RTP allows data transfer to multiple destinations through IP multicast or to a specific destination through IP unicast. The majority of the RTP implementations are built on top of the User Datagram Protocol (UDP). Other transport protocols may also be utilized. RTP is used in together with other protocols such as H.323 and Real Time Streaming Protocol RTSP.

The RTP specification describes two protocols: RTP and RTCP. RTP is used for the transfer of multimedia data, and its companion protocol (RTCP) is used to periodically send control information and QoS parameters.

RTP sessions are typically initiated between client and server or between client and another client (or a multi-party topology) using a signaling protocol, such as H.323, the Session Initiation Protocol (SIP), or RTSP. These protocols typically use the Session Description Protocol (RFC 8866) to specify the parameters for the sessions.

RTP—Profiles and payload Formats

RTP is designed to carry a multitude of multimedia formats, which permit the transport of new formats without revising the RTP standard. To this end, the information required by a specific application of the protocol is not included in the generic RTP header. For a class of applications (e.g., audio, video), an RTP profile may be defined. For a media format (e.g., a specific video coding format), an associated RTP payload format may be defined. Every instantiation of RTP in a particular application may require a profile and payload format specifications.

The profile defines the codecs used to encode the payload data and their mapping to payload format codes in the protocol field Payload Type (PT) of the RTP header.

For example, the RTP profile for audio and video conferences with minimal control is defined in RFC 3551. The profile defines a set of static payload type assignments, and a dynamic mechanism for mapping between a payload format, and a PT value using Session Description Protocol (SDP). The latter mechanism is used for newer video codec such as RTP payload format for H.264 Video defined in RFC 6184 or RTP Payload Format for High Efficiency Video Coding (HEVC) defined in RFC 7798.

### RTP—RTP Session

An RTP session is established for each multimedia stream. Audio and video streams may use separate RTP sessions, enabling a receiver to selectively receive components of a particular stream. The RTP specification recommends even port numbers for RTP, and the use of the next odd port number for the associated RTCP session. A single port can be used for RTP and RTCP in applications that multiplex the protocols.

Each RTP stream consists of RTP packets, which in turn consist of RTP header and payload pairs.

### SDP—Session Description Protocol

The Session Description Protocol (SDP) is a format for describing multimedia communication sessions for the purpose of announcement and invitation. Its predominant use is in support of streaming media applications. SDP does not deliver any media streams itself but is used between endpoints for negotiation of network metrics, media types, bandwidth requirements, and other associated properties. The set of properties and parameters is called a session profile. SDP is extensible for the support of new media types and formats. SDP is widely deployed in the industry and is used for session initialization by various other protocols such as SIP or WebRTC related session negation.

The Session Description Protocol describes a session as a group of fields in a text-based format, one field per line. The form of each field is as follows.

<character>=<value><CR><LF>

Where <character> is a single case-sensitive character and <value> is structured text in a format that depends on the character. Values are typically UTF-8 encoded. Whitespace is not allowed immediately to either side of the equal sign.

Session descriptions consist of three sections: session, timing, and media descriptions. Each description may contain multiple timing and media descriptions. Names are only unique within the associated syntactic construct.

Fields must appear in the order shown; optional fields are marked with an asterisk

v = (protocol version number, currently only 0)
o = (originator and session identifier: username, id,
version number, network address)
s = (session name: mandatory with at least one UTF-8-
encoded character)
i = * (session title or short information)
u = * (URI of description)
e = * (zero or more email address with optional name of
contacts)
p = * (zero or contacts) number with name of
more phone optional
c = * (connection information-not required if included in all
media)
b = * (zero or more bandwidth information lines)
One or more time descriptions (“t = ” and “r = ” lines; see
below)
z = * (time zone adjustments)
k = * (encryption key)
a = * (zero or more session attribute lines)
Zero or more Media descriptions (each one starting by an
“m =” line; see below)

### Time Description (Mandatory)

t = (time the session is active)
r = * (zero or more repeat times)

### Media Description (Optional)

m = (media name and transport address)
i = * (media title or information field)
c = * (connection information-optional if included at session
level)
b = * (zero or more bandwidth information lines)
k = * (encryption key)
a = * (zero or more media attribute lines-overriding the
Session attribute lines)

Below is a sample session description from RFC 4566. This session is originated by the user “Jdoe”, at IPv4 address 10.47.16.5. Its name is “SDP Seminar” and extended session information (“A Seminar on the session description protocol”) is included along with a link for additional information and an email address to contact the responsible party, Jane Doe. This session is specified to last for two hours using NTP timestamps, with a connection address (which indicates the address clients must connect to or—when a multicast address is provided, as it is here—subscribe to) specified as IPv4 224.2.17.12 with a TTL of 127. Recipients of this session description are instructed to only receive media. Two media descriptions are provided, both using the RTP Audio/Video Profile. The first is an audio stream on port 49170 using RTP/AVP payload type 0 (defined by RFC 3551 as PCMU), and the second is a video stream on port 51372 using RTP/AVP payload type 99 (defined as “dynamic”). Finally, an attribute is included which maps RTP/AVP payload type 99 to format h263-1998 with a 90 kHz clock rate. RTCP ports for the audio and video streams of 49171 and 51373, respectively, are implied.

v = 0
o = jdoe 2890844526 2890842807 IN IP4 10.47.16.5
s = SDP Seminar
i = A Seminar on the session description protocol
u = http://www.example.com/seminars/sdp.pdf
e = j.doe@example.com (Jane Doe)
c = IN IP4 224.2.17.12/127
t = 2873397496 2873404696
a = recvonly
m = audio 49170 RTP/AVP 0
m = video 51372 RTP/AVP 99
a = rtpmap: 99 h263-1998/90000

### SDP—Attributes

SDP uses attributes to extend the core protocol. Attributes can appear within the Session or Media sections and are scoped accordingly as session-level or media-level. New attributes can be added to the standard through registration with IANA. List of all registered attributes can be found at https://www.iana.org/assignments/sdp-parameters/sdp-parameters.xhtml#sdp-att-field. A media description may contain any number of “a=” lines (attribute-fields) that are media description specific. Session-level attributes convey additional information that applies to the session as a whole rather than to individual media descriptions.

### Attributes are Either Properties or Values:

a=<attribute-name>
a=<attribute-name>:<attribute-value>

Examples of attributes defined in RFC8866 are “rtpmap” and “fmtp”.

“rtpmap” attribute maps from an RTP payload type number (as used in an “m=” line) to an encoding name denoting the payload format to be used. It also provides information on the clock rate and encoding parameters. Up to one “a=rtpmap:” attribute can be defined for each media format specified. Thus, we might have the following:

m=audio 49230 RTP/AVP 96 97 98
a=rtpmap: 96 EVS/16000
a=rtpmap: 97 L16/8000
a=rtpmap: 98 L16/11025/2

In the example above, the media types are “audio/EVS” and “audio/L16”.

Parameters added to an “a=rtpmap:” attribute should only be those required for a session directory to make the choice of appropriate media to participate in a session. Codec-specific parameters should be added in other attributes, for example, “fmtp”.

“fmtp” attribute allows parameters that are specific to a particular format to be conveyed in a way that SDP does not have to understand them. The format must be one of the formats specified for the media. Format-specific parameters, semicolon separated, may be any set of parameters required to be conveyed by SDP and given unchanged to the media tool that uses this format. At most one instance of this attribute is allowed for each format. An example is:

a=fmtp: 96 br=16.4; bw=nb-swb; max-red=220

For example EVS defines the following ptime, maxptime, evs-mode-switch, hf-only, dtx, dtx-recv, max-red, channels, cmr, br, br-send, br-recv, bw, bw-send, bw-recv, ch-send, ch-recv, and ch-aw-recv.

The conversational audio codec session negotiation is currently limited to scenarios which don't allow rendering of audio with different inputs. Typically, the audio input is limited to mono audio.

The following problems motivate the definition of new session negotiation parameters for IVAS:

1. The upcoming IVAS standard supports a large number of input formats. There is a clear impact of the input format in scenarios where the receiver intends to use an external renderer which depends on a particular input format. For example, if an external renderer at the receiver UE depends on MASA format for performing rendering, it is required for the receiver UE to negotiate the input format from the sender UE to be MASA input format for IVAS codec. There is no mechanism to enable such capability indication in the session negotiation for conversational audio codecs. In short, there is a clear need to reach a mutually agreeable input format.

2. The receiver UE may wish a particular input format which may be better suited for certain types of rendering the output. For example, channel input format might be suitable if the receiver UE intends to render the IVAS output via a loudspeaker system whereas MASA format might be suitable for a MASA based head tracked rendering via a Nokia proprietary external renderer. Thus depending on the output scenario, the receiver UE may wish to negotiate the most appropriate input format.

3. There is a need to indicate the output format of the renderer in order to enable the sender UE encoder to generate IVAS bitstream such that it is optimal for the specific output format.

4. There is a need to inform the rate adaptation process of the sender UE which has the flexibility to switch across different input modes as well as the bitrates.

The examples described herein address the above described problems.

The EVS codec (presented in 3GPP TS 26.445) operates only in mono mode, it does not support other input or output formats. The codec can operate in EVS Primary or EVS AMR-WB IO modes. During the session negotiation, the operating mode used at the start of the session is indicated with evs-mode-switch parameter, with permissive values of 0 (EVS Primary) and 1 (EVS AMR-WB IO). The parameter reflects to the mode used for the codec and not the input format, which is mono in both cases. As such, a similar parameter could not be used for IVAS, which supports multiple input formats.

The EVS AMR-WB IO mode can have a mode-set parameter configured during the session negotiation. The parameter contains a list of supported operating modes for the codec during the session. The modes are selected from a table, which indicates different bitrate operating modes for EVS AMR-WB IO. In EVS, the different codec modes are uniquely described by the used bitrate. For example, a bitrate of 8 kbps is reserved for EVS Primary mode only, and EVS AMR-WB IO does not have an operating mode with this bitrate. In IVAS, similar unique identification of operating modes based on bitrate is not possible, because the same bitrates are operable for multiple different input formats.

As EVS codec does not support other than mono input, the negotiation requirements related to multiple input formats and the consequent rate adaptation approach negotiation is not covered in the prior art. Similarly, EVS or any other codec currently does not support definition of output format in case of conversational audio session negotiation. Multi-mono operation is possible using multiple instances of the EVS encoder and decoder. There is no standardized mechanism to, e.g., synchronize the two or more instances on signal level.

The examples described herein relate to immersive voice and audio services codec session negotiation where there is provided a method for selecting a preferred and mutually supported input format for the immersive conversational voice codec to achieve the functionality of selecting the input format that is optimally suited for at least one of an external renderer or a preferred output format. This is performed by providing and a sender UE and a receiver UE.

### Sender UE:

Obtain the one or more supported input formats
Sort the input formats in the preferred order (e.g., based on encoding computational complexity or UE audio capture capabilities)
Include the immersive conversational codec input formats attribute in the session description file
Populate the input format attribute with the sorted list of immersive conversational codec input formats in the session description file
Generate the session description offer
Transmit the session negotiation offer to the receiver UE

### Receiver UE:

Receive the session negotiation offer
Parse the immersive conversational codec input format from the received session description file in the offer
Obtain the supported and preferred input format by the receiver UE
Select the preferred one or more input formats from the received session description offer which are common with the receiver UE preferred input format
Include the immersive conversational codec input format attribute
Populate the immersive conversational codec input format attribute with the preferred one or more input format
Transmit the session negotiation answer to the sender UE

The examples described herein relate to immersive voice and audio services codec session negotiation where there is provided a method for selecting a preferred and mutually supported input format for the immersive conversational voice codec to achieve the functionality of selecting the input format that is optimally suited for the sender UE while serving an audio bitstream that is suitable for the receiver UE.

In an embodiment, the session description file comprises the input format indication, output format indication, format switching for bitrate adaptation as an attribute or media format parameter.

In an embodiment, the session negotiation description is represented as a session description protocol file (SDP).

In an embodiment, the session negotiation is performed as session description offer answer model.

In another embodiment, if the answer from the receiver UE comprises a single input format, the sender UE bitrate adaptation is constrained to a single input format.

In another embodiment, if the answer from the receiver UE comprises two or more input formats, the sender UE bitrate adaptation is flexible to utilize any of the agreed input formats.

In an embodiment, the codec format is indicated as immersive voice and audio codec (IVAS) for the session negotiation with bitstream constrained to immersive conversational audio codec bitstreams and not include enhance voice codec (EVS) bitstream for rate adaptation.

In another embodiment, an input format is included as a media format parameter or as an attribute in the session description file with the corresponding codec parameter being the immersive voice and audio codec parameter.

The use of EVS codec in the session description results in fall back to TS 26.445, which also covers interoperability of EVS with AMR-WB IO mode. For IVAS payload format IVAS is used as the codec name in the session description.

In Table 3, different IVAS input formats are assigned to numeric values of a parameter inf. The parameter is explained in more detail below.

Table 3 shows IVAS input formats and their assigned inf attribute values.

TABLE 3

| IVAS input format | Attribute inf value |
|---|---|
| Stereo | 1 |
| Binaural | 2 |
| Multichannel (5.1, 7.1, 5.1.2, 5.1.4, | 3-7 |
| 7.1.4) | |
| MASA | 8 |
| ISM (1, 2, 3, 4 objects) | 9-12 |
| SBA (FOA, HOA2, HOA3) | 13-15 |
| OMASA (1, 2, 3, 4 objects) | 16-19 |

In Table 4, different IVAS output formats are assigned to numeric values of a parameter outf. The parameter is explained in more detail below. The external output format indicates a (non-rendered) output. For example, the receiver is using an external renderer. The passthrough although listed as a type of output format, is actually an operation of the IVAS codec which results in producing an output format attribute that is same as the input format or in other words, maintains the input stream format at the output. Similarly, External mode refers to needing an external rendering to listen to the audio, but not necessarily using an external renderer to do so.

Table 4 shows IVAS output formats and their assigned outf attribute values.

TABLE 4

| IVAS output format | Attribute outf value |
|---|---|
| Mono | 1 |
| Stereo | 2 |
| Binaural | 3 |
| Binaural room | 4 |
| Multichannel (5.1, 7.1, 5.1.2, | 5-10 |
| 5.1.4, 7.1.4, custom) | |
| SBA (FOA, HOA2, HOA3) | 11-13 |
| Passthrough mode | 14 |
| External mode | 15 |

Table 5 presents specific operating modes of each IVAS output format, parameterized with outf-specific-mode parameter. For example, an external renderer can indicate which output format it is using with the outf-specific-mode parameter. Table 6 shows another embodiment, where the specific operating modes for the output formats are included in the outf parameter, in which case the outf-specific-mode parameter is not needed. The parameter outf-specific-mode is described in more detail below.

Table 5 shows IVAS output formats and their specific operating mode attributes outf-specific-mode. XX indicates that the output format does not have specific operating modes.

TABLE 5

| IVAS output format | Attribute outf-specific-mode value |
|---|---|
| Mono | XX |
| Stereo | XX |
| Binaural | XX |
| Binaural room | XX |
| Multichannel (5.1, 7.1, 5.1.2, | XX |
| 5.1.4, 7.1.4, custom) | |
| SBA (FOA, HOA2, HOA3) | XX |
| Passthrough mode | XX |
| External mode | Mono, stereo, MC (5.1, 7.1, 5.1.2, 5.1.4, |
| | 7.1.4), SBA (FOA, HOA2, HOA3), |
| | binaural, binaural room |

Table 6 shows IVAS output formats and their assigned outf attribute values. This table incorporates outf-specific-mode to the output formats.

TABLE 6

| IVAS output format | Attribute outf value |
|---|---|
| Mono | 1 |
| Stereo | 2 |
| Binaural | 3 |
| Binaural room | 4 |
| Multichannel (5.1, 7.1, 5.1.2, 5.1.4, 7.1.4, | 5-10 |
| custom) | |
| SBA (FOA, HOA2, HOA3) | 11-13 |
| Passthrough mode | 14 |
| External mode (mono, stereo, MC (5.1, | 15 -27 |
| 7.1, 5.1.2, 5.1.4, 7.1.4, custom), SBA | |
| (FOA, HOA2, HOA3), binaural, binaural | |
| room) | |

inf: Indicates the input format capability. In case a range of input formats is supported, it is indicated by the first input format in the range and the last in the range separated by a hyphen (inf1-inf2). In case of multiple input formats that are not a contiguous range but individual formats, those are listed as comma separated values (inf1, inf2). Comma separated values are also used, when the input formats are within a range, but the preferred order of the formats is not the default contiguous range. In both cases, hyphen or comma separated list, the input formats are listed in a preferred order from the most preferred to the least preferred input format. inf-send and inf-recv are used in case of different input formats are used in both the send and receive directions respectively. If inf parameter is not present, all possible IVAS input formats are supported.

disable-inf-switch: A flag defined to restrict the input format switching. Permissible values are 0 and 1. If disable-inf-switch is 0 or not present, the sender is allowed to switch between the negotiated IVAS input formats. If disable-inf-switch is 1, the sender is not allowed to switch the IVAS input format during the session.

outf: Indicates the output format capability. In case a range of output formats is supported, it is indicated by the first output format in the range and the last in the range separated by a hyphen (outf1-outf2). In case of multiple output formats that are not a contiguous range but individual formats, those are listed as comma separated values (out1, out2). Comma separated values are also used, when the output formats are within a range, but the preferred order of the formats is not the default contiguous range. In both cases, hyphen or comma separated list, the output formats are listed in a preferred order from the most preferred to the least preferred output format. outf-send and outf-recv are used in case of different output formats are used in both the send and receive directions respectively. If outf parameter is not present, all possible IVAS output formats are supported.

outf-specific-mode: Indicates the specific operating mode(s) for the output format(s). In case a range of specific operating modes is supported, it is indicated by the first mode in the range and the last in the range separated by a hyphen (outf-specific-model-outf-specific-mode2). In case of multiple specific operating modes that are not a contiguous range but individual modes, those are listed as comma separated values (outf-specific-mode1, outf-specific-mode2). Comma separated values are also used, when the specific operating modes are within a range, but the preferred order of the modes is not the default contiguous range. In both cases, hyphen or comma separated list, the specific operating modes are listed in a preferred order from the most preferred to the least preferred mode. outf-specific-mode-send and outf-specific-mode-recv are used in case of different specific operating modes are used in both the send and receive directions respectively. If outf-specific-mode is not present, all possible specific input modes are supported. Some IVAS output formats can have only a single operating mode, in which case the outf-specific-mode parameter is redundant.

Parameters br, ptime and maxptime in the examples below follow the definitions presented in EVS specification (3GPP TS 26.445). In summary, the parameters represent:

br: Indicates the bitrate for the session in kilobits per second. The parameter can either have a single value (br0), or a hyphen-separated pair of two bitrates (br1-br2), where br1 and br2 are used as the minimum and maximum bitrates respectively.

ptime: Packet time, the length of time in milliseconds represented by the media in a packet. In IVAS, ptime is set to 20 ms.

maxptime: Indicates the maximum amount of media that can be encapsulated in each packet in milliseconds. For frame-based codecs like IVAS, the time should be an integer multiple of the frame size (20 ms for IVAS).

Example 1 below describes an example SDP offer-answer negotiation for initiating the session. The media line (m-line) describes the port used for the session (49152). RTP/AVP stands for RTP profile for audio and video and 96 is an indicator for a dynamic payload type. The type for payload number 96 is further described on the rtpmap- and fmtp-lines.

The rtpmap-line indicates the use of an IVAS codec with 16 kHz timestamp clock frequency. The used clock frequency for IVAS has not been decided yet and is subject to change before the standard is complete. EVS codec is using 16 kHz clock frequency, and the same value is used in the examples below. Timestamp is one of the fields in the fixed RTP header. It is incremented throughout the session and reflects to the packet flow from a sender to a receiver. With 20 ms speech frame-blocks and 16 kHz timestamp clock frequency, the timestamp value is increased by 320 for each consecutive frame-block.

In the SDP offer, the fmtp-line indicates the supported input formats of the sender in the inf parameter. The range 3-19 refers to inf values presented in Table 3. The range of values indicate that the sender supports all the values between and including 3-19. A bitrate of 512 kbps is offered for the session.

The receiver sends an SDP answer to the sender with a modified fmtp-line. The receiver has chosen two preferred input formats for the sender to use (19=OMASA with 4 objects and 8=MASA) and has sorted the formats in a preferred order, where 19 is more preferable than 8. The sender should use IVAS input format 19 during the session.

Example 1 is an example SDP offer-answer scenario, where the sender offers IVAS input modes 3-19 and the receiver answers with a list of preferred input modes for the sender to use (19,8).

### Example 1

Example SDP Offer
m=audio 49152 RTP/AVP 96
a=rtpmap: 96 IVAS/16000
a=fmtp: 96 inf=3-19; br=512
a=ptime:20
a=maxptime:240
Example SDP Answer
m=audio 49152 RTP/AVP 96
a=rtpmap:96 IVAS/16000
a=fmtp:96 inf=19,8; br=512
a=ptime:20
a=maxptime:240

Example 2 describes another SDP offer-answer scenario. The sender offers IVAS input modes 8 (MASA), 17 (OMASA with 2 objects) and 10 (ISM with 2 objects) and a bitrate range of 128-512 kbps. In this example, the receiver prefers to use a single input mode across all available bitrates. However, only MASA and OMASA support the whole offered bitrate range from the offered input modes (ISM with 2 objects does not support bitrates higher than 256 kbps). The receiver sends an SDP answer, which indicates preferred input modes 17 and 8 in that order. If the bitrate changes between the negotiated range during the session, the most preferred mode (17) should be used by the sender. However, the sender is not prohibited to switch to use input mode 8 (MASA) in some situations. In an example situation, the sender is unexpectedly under heavy computational load and wants to use an input mode, which is computationally less complex to process. In this situation, the sender may switch to use any input mode within the negotiated input modes that is computationally less complex. If the receiver wants to explicitly prohibit input mode switching during the session, the receiver can select only a single input mode as described in Example 3 or include disable-inf-switch parameter in the SDP answer as described in Example 4.

Example 2 is an example SDP offer-answer scenario, where the sender offers IVAS input modes 8, 17 and 10 and a bitrate range of 128-512 kbps. The receiver excludes input mode 10 from the answer, because the mode does not support the whole bitrate range and might cause input mode switching, if the bitrate changes during the session.

### Example 2

Example SDP Offer
m=audio 49152 RTP/AVP 96
a=rtpmap:96 IVAS/16000
a=fmtp:96 inf=8,17,10; br=128-512
a=ptime:20
a=maxptime:240
Example SDP Answer
m=audio 49152 RTP/AVP 96
a=rtpmap:96 IVAS/16000
a=fmtp:96 inf=17, 8; br=128-512
a=ptime:20
a=maxptime:240

Example 3 describes another SDP offer-answer scenario. The sender offers VAS input modes 8 (MASA), 17 (OMASA with 2 objects) and 10 (ISM with 2 objects) and a bitrate range of 128-512 kbps. In this example, the receiver prefers to use a single input mode across all available bitrates. The receiver prefers the input mode 17 and includes only that input mode in the SDP answer.

Example 3 is an example SDP offer-answer scenario, where the sender offers IVAS input modes 8, 17 and 10, and the receiver selects only a single input mode (17).

### Example 3

Example SDP Offer
m=audio 49152 RTP/AVP 96
a=rtpmap:96 IVAS/16000
a=fmtp:96 inf=8, 17, 9; br=128-512
a=ptime:20
a=maxptime:240
Example SDP Answer
m=audio 49152 RTP/AVP 96
a=rtpmap:96 IVAS/16000
a=fmtp:96 inf=17; br=128-512
a=ptime:20
a=maxptime:240

Example 4 describes another SDP offer-answer scenario. The sender offers IVAS input modes 8 (MASA), 17 (OMASA with 2 objects) and 10 (ISM with 2 objects) and a bitrate range of 80-512 kbps. The receiver sends an answer to the sender, which indicates preferred input modes 17 and 8 in that order. To prevent input mode switching during the session, the receiver also includes disable-inf-switch=1 parameter value in the answer to restrict input mode switching between the two input modes. The set parameter prevents the sender to switch the input mode e.g. in a scenario, where the bitrate switches during the session.

Example 4 is an example SDP offer-answer scenario, where the sender offers IVAS input modes 8, 17 and 10 and a bitrate range of 80-512 kbps. The receiver prefers input modes 17 and 8 in that order and includes those modes in the answer. The receiver also wants to avoid input mode switching during the session and includes disable-inf-switch=1 parameter in the answer.

### Example 4

Example SDP Offer
m=audio 49152 RTP/AVP 96
a=rtpmap:96 IVAS/16000
a=fmtp:96 inf=8,17,10; br=80-512
a=ptime:20
a=maxptime:240
Example SDP Answer
m=audio 49152 RTP/AVP 96
a=rtpmap: 96 IVAS/16000
a=fmtp:96 inf=17, 8; br=80-512; disable-inf-switch=1
a=ptime:20
a=maxptime:240

Example 5 describes another SDP offer-answer scenario. The sender offers all possible IVAS input modes and a bitrate range of 13.2-512 kbps. The receiver prefers to support only the highest bitrates and indicates this in the answer as a bitrate range of 384-512 kbps. The chosen bitrate range also limits the availability of the input modes, since not all the offered modes support the highest bitrates. The receiver prefers input modes 8 (MASA) and 17 (OMASA with 2 objects) in that order and indicates this in the SDP answer. Both of the preferred modes support the negotiated bitrate range.

Example 5 is an example SDP offer-answer scenario, where the sender offers all possible IVAS input modes and a bitrate range of 13.2-512 kbps. The receiver answers with a range of high bitrates (384-512 kbps) which limits the availability of the input modes. The receiver prefers input modes 8 and 17, which both support the negotiated bitrate range.

### Example 5

Example SDP Offer
m=audio 49152 RTP/AVP 96
a=rtpmap:96 IVAS/16000
a=fmtp:96 inf=1-19; br=13.2-512
a=ptime:20
a=maxptime:240
Example SDP Answer
m=audio 49152 RTP/AVP 96
a=rtpmap:96 IVAS/16000
a=fmtp:96 inf=8, 17; br=384-512
a=ptime:20
a=maxptime:240

Example 6 describes another SDP offer-answer scenario. The sender offers all possible IVAS input modes and a bitrate range of 13.2-512 kbps. The receiver prefers to support only the highest bitrates and indicates this in the answer as a bitrate range of 384-512 kbps. The receiver is using an external renderer (outf=15) with a binaural output setting (outf-specific-mode=binaural). In this example, the external renderer is especially tuned for MASA-type input, and the receiver prefers input modes 8 (MASA) and 17 (OMASA with 2 objects) in that order and indicates this in the SDP answer.

Example 6 is an example SDP offer-answer scenario, where the sender offers all possible IVAS input modes and a bitrate range of 13.2-512 kbps. The receiver answers with a range of high bitrates (384-512 kbps). The receiver prefers input modes 8 and 17, because the receiver is using an external renderer that is especially tuned for MASA-type input.

### Example 6

Example SDP Offer
m=audio 49152 RTP/AVP 96
a=rtpmap: 96 IVAS/16000
a=fmtp:96 inf=1-19; br=13.2-512
a-ptime:20
a=maxptime:240
Example SDP Answer
m=audio 49152 RTP/AVP 96
a=rtpmap:96 IVAS/16000
a=fmtp:96 inf=8,17;
outf=15;
outf-specific-mode=binaural;
br=384-512
a=ptime:20
a=maxptime:240

In another embodiment, the disable-inf-switch parameter can be extended to allow more specific control on the restricted mode switching. A parameter value of 0 or not present would mean that the sender is allowed to switch between the negotiated IVAS input formats. A value of 1 would indicate that the sender is not allowed to switch between the input formats that are not grouped together. E.g. all of the multichannel formats can be grouped under MC, and with disable-inf-switch=1 the sender would be allowed to switch between the different MC formats. In the context of the examples described herein, this restriction would mean that the sender is not allowed to switch between input formats that are not present on the same row in Table 3. I.e. the sender would be allowed to switch between different MC or SBA formats, if those formats are negotiated. A disable-inf-switch parameter value of 2 would indicate that also the switching inside a grouped input format is restricted, i.e. the sender is not allowed to switch between any IVAS input formats, including different MC or SBA formats.

Example 7 demonstrates the use of an alternative version of disable-inf-switch as described above. The sender offers IVAS input formats 3-8 (MC modes and MASA) and bitrates 13.2-512. The receiver answers with the offered input modes and bitrates and additionally includes a disable-inf-switch=1 parameter. The parameter indicates that the sender is not allowed to switch between MC input format (3-7) and MASA (8), but the sender is allowed to switch between different MC input formats.

Example 7 is an example SDP offer-answer scenario, where the sender offers IVAS input modes 3-8 and a bitrate range of 13.2-512 kbps. The receiver answers with the offered modes and bitrates but adds a disable-inf-switch=1 parameter (which refers to an alternative implementation embodiment of the parameter, described above). The added parameter restricts the sender from switching from MC input formats (3-7) to MASA (8) but allows the sender to switch between MC modes.

### Example 7

Example SDP Offer
m=audio 49152 RTP/AVP 96
a=rtpmap:96 IVAS/16000
a=fmtp:96 inf=3-8; br=13.2-512
a=ptime:20
a-maxptime:240
Example SDP Answer
m=audio 49152 RTP/AVP 96
a=rtpmap:96 IVAS/16000
a=fmtp:96 inf=3-8; disable-inf-switch=1; br=13.2-512
a=ptime:20
a=maxptime:240

Accordingly, the examples described herein relate to IVAS standardization (normative specifications) and particularly the RTP payload and signaling aspects including session negotiation. The 3GPP TS 26.253 specification “Codec for immersive voice and audio services—Detailed Algorithmic Description incl. RTP payload format and SDP parameter definitions” may adopt any of the examples described herein.

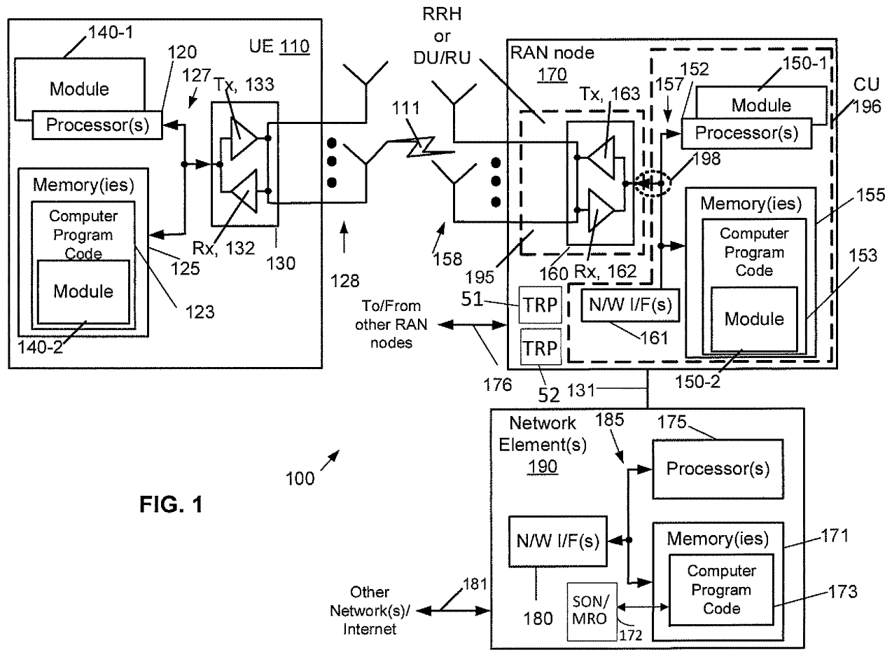

Turning to FIG. 1, this figure shows a block diagram of one possible and non-limiting example in which the examples may be practiced. A user equipment (UE) 110, radio access network (RAN) node 170, and network element(s) 190 are illustrated, which may be used to communicate over VoLTE and 5G and beyond. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 in this example is a base station that provides access for wireless devices such as the UE 110 to the wireless network 100. The RAN node 170 may be, for example, a base station for 5G, also called New Radio (NR). In 5G, the RAN node 170 may be a NG-RAN node, which is defined as either a gNB or an ng-eNB. A gNB is a node providing NR user plane and control plane protocol terminations towards the UE, and connected via the NG interface (such as connection 131) to a 5GC (such as, for example, the network element(s) 190). The ng-eNB is a node providing E-UTRA user plane and control plane protocol terminations towards the UE, and connected via the NG interface (such as connection 131) to the 5GC. The NG-RAN node may include multiple gNBs, which may also include a central unit (CU) (gNB-CU) 196 and distributed unit(s) (DUs) (gNB-DUs), of which DU 195 is shown. Note that the DU 195 may include or be coupled to and control a radio unit (RU). The gNB-CU 196 is a logical node hosting radio resource control (RRC), SDAP and PDCP protocols of the gNB or RRC and PDCP protocols of the en-gNB that control the operation of one or more gNB-DUs. The gNB-CU 196 terminates the F1 interface connected with the gNB-DU 195. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU 195 is a logical node hosting RLC, MAC and PHY layers of the gNB or en-gNB, and its operation is partly controlled by gNB-CU 196. One gNB-CU 196 supports one or multiple cells. One cell may be supported with one gNB-DU 195, or one cell may be supported/shared with multiple DUs under RAN sharing. The gNB-DU 195 terminates the F1 interface 198 connected with the gNB-CU 196. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, one or more memories 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU 195, and the one or more buses 157 could be implemented in part as, for example, fiber optic cable or other suitable network connection to connect the other elements (e.g., a central unit (CU), gNB-CU 196) of the RAN node 170 to the RRH/DU 195. Reference 198 also indicates those suitable network link(s).

A RAN node/gNB can comprise one or more TRPs to which the methods described herein may be applied. FIG. 1 shows that the RAN node 170 comprises two TRPs, TRP 51 and TRP 52. The RAN node 170 may host or comprise other TRPs not shown in FIG. 1.

A relay node in NR is called an integrated access and backhaul node. A mobile termination part of the IAB node facilitates the backhaul (parent link) connection. In other words, the mobile termination part comprises the functionality which carries UE functionalities. The distributed unit part of the IAB node facilitates the so called access link (child link) connections (i.e. for access link UEs, and backhaul for other IAB nodes, in the case of multi-hop IAB). In other words, the distributed unit part is responsible for certain base station functionalities. The IAB scenario may follow the so called split architecture, where the central unit hosts the higher layer protocols to the UE and terminates the control plane and user plane interfaces to the 5G core network.

It is noted that the description herein indicates that “cells” perform functions, but it should be clear that equipment which forms the cell may perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include location management functions (LMF(s)) and/or access and mobility management function(s) (AMF(S)) and/or user plane functions (UPF(s)) and/or session management function(s) (SMF(s)). Such core network functionality for LTE may include MME (mobility management entity)/SGW (serving gateway) functionality. Such core network functionality may include SON (self-organizing/optimizing network) functionality. These are merely example functions that may be supported by the network element(s) 190, and note that both 5G and LTE functions might be supported. The RAN node 170 is coupled via a link 131 to the network element 190. The link 131 may be implemented as, e.g., an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. Computer program code 173 may include SON and/or MRO functionality 172.

The wireless network 100 may implement network virtualization, which is the process of combining hardware and software network resources and network functionality into a single, software-based administrative entity, or a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, non-transitory memory, transitory memory, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, network element(s) 190, and other functions as described herein.

In general, the various example embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback devices having wireless communication capabilities, internet appliances including those permitting wireless internet access and browsing, tablets with wireless communication capabilities, head mounted displays such as those that implement virtual/augmented/mixed reality, as well as portable units or terminals that incorporate combinations of such functions. The UE 110 can also be a vehicle such as a car, or a UE mounted in a vehicle, a UAV such as e.g. a drone, or a UE mounted in a UAV. The user equipment 110 may be terminal device, such as mobile phone, mobile device, sensor device etc., the terminal device being a device used by the user or not used by the user.

UE 110, RAN node 170, and/or network element(s) 190, (and associated memories, computer program code and modules) may be configured to implement (e.g. in part) the methods described herein, including a method and apparatus for negotiation of a conversational immersive audio session. Thus, computer program code 123, module 140-1, module 140-2, and other elements/features shown in FIG. 1 of UE 110 may implement user equipment related aspects of the examples described herein. Similarly, computer program code 153, module 150-1, module 150-2, and other elements/features shown in FIG. 1 of RAN node 170 may implement gNB/TRP related aspects of the examples described herein. Computer program code 173 and other elements/features shown in FIG. 1 of network element(s) 190 may be configured to implement network element related aspects of the examples described herein.

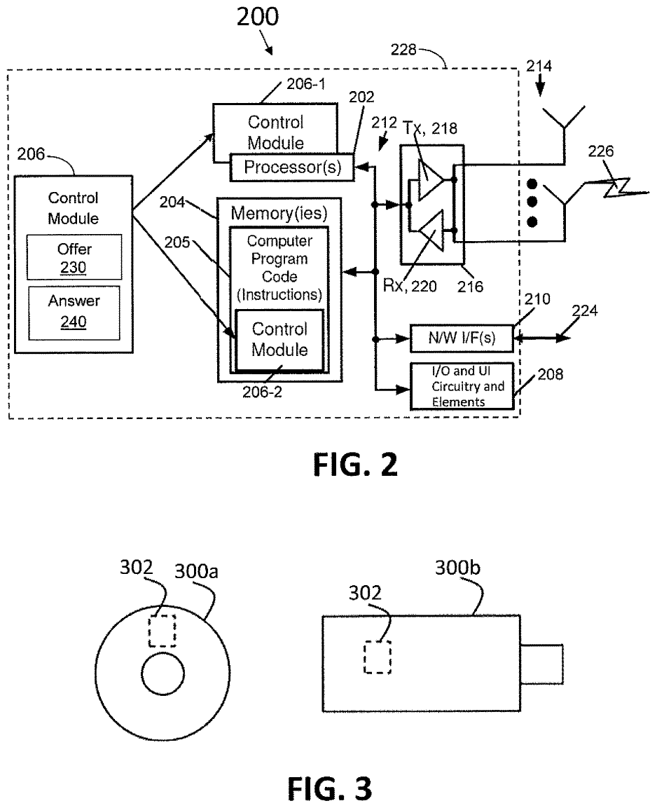

FIG. 2 is an example apparatus 200, which may be implemented in hardware, configured to implement the examples described herein. The apparatus 200 comprises at least one processor 202 (e.g. an FPGA and/or CPU), one or more memories 204 including computer program code 205, the computer program code 205 having instructions to carry out the methods described herein, wherein the at least one memory 204 and the computer program code 205 are configured to, with the at least one processor 202, cause the apparatus 200 to implement circuitry, a process, component, module, or function (implemented with control module 206) to implement the examples described herein, including a method for negotiation of a conversational immersive audio session. Offer 230 of the control module 206 may perform generating or receiving the offer (e.g. SDP offer), and answer 240 may implement generating or receiving the answer (e.g. SDP answer). The memory 204 may be a non-transitory memory, a transitory memory, a volatile memory (e.g. RAM), or a non-volatile memory (e.g. ROM).

The apparatus 200 includes a display and/or I/O interface 208, which includes user interface (UI) circuitry and elements, that may be used to display aspects or a status of the methods described herein (e.g., as one of the methods is being performed or at a subsequent time), or to receive input from a user such as with using a keypad, camera, touchscreen, touch area, one microphone or a plurality of microphones, biometric recognition, one or more sensors, etc. For immersive voice and audio, the examples described herein generally concern devices that have or connect to at least two microphones, e.g., high-quality parametric spatial audio capture for MASA format generally uses at least 3 microphones.

The apparatus 200 includes one or more communication e.g. network (N/W) interfaces (I/F(s)) 210. The communication I/F(s) 210 may be wired and/or wireless and communicate over the Internet/other network(s) via any communication technique including via one or more links 224. The communication I/F(s) 210 may comprise one or more transmitters or one or more receivers.

The transceiver 216 comprises one or more transmitters 218 and one or more receivers 220. The transceiver 216 and/or communication I/F(s) 210 may comprise standard well-known components such as an amplifier, filter, frequency-converter, (de)modulator, and encoder/decoder circuitries and one or more antennas, such as antennas 214 used for communication over wireless link 226.

The control module 206 of the apparatus 200 comprises one of or both parts 206-1 and/or 206-2, which may be implemented in a number of ways. The control module 206 may be implemented in hardware as control module 206-1, such as being implemented as part of the one or more processors 202. The control module 206-1 may be implemented also as an integrated circuit or through other hardware such as a programmable gate array. In another example, the control module 206 may be implemented as control module 206-2, which is implemented as computer program code (having corresponding instructions) 205 and is executed by the one or more processors 202. For instance, the one or more memories 204 store instructions that, when executed by the one or more processors 202, cause the apparatus 200 to perform one or more of the operations as described herein. Furthermore, the one or more processors 202, one or more memories 204, and example algorithms (e.g., as flowcharts and/or signaling diagrams), encoded as instructions, programs, or code, are means for causing performance of the operations described herein.

The apparatus 200 to implement the functionality of control 206 may correspond to any of UE 110, RAN node 170, or network element(s) 190. Alternatively, apparatus 200 and its elements may not correspond to any of the apparatuses depicted in FIG. 1, as apparatus 200 may be part of a self-organizing/optimizing network (SON) node or other node, such as a node in a cloud.

The apparatus 200 may also be distributed throughout the network (e.g. internet 28) including within and between apparatus 200 and UE 110, RAN node 170, or network element(s) 190.

Interface 212 enables data communication and signaling between the various items of apparatus 200, as shown in FIG. 2. For example, the interface 212 may be one or more buses such as address, data, or control buses, and may include any interconnection mechanism, such as a series of lines on a motherboard or integrated circuit, fiber optics or other optical communication equipment, and the like. Computer program code (e.g. instructions) 205, including control 206 may comprise object-oriented software configured to pass data or messages between objects within computer program code 205. The apparatus 200 need not comprise each of the features mentioned, or may comprise other features as well. The various components of apparatus 200 may at least partially reside in a common housing 228, or a subset of the various components of apparatus 200 may at least partially be located in different housings, which different housings may include housing 228.

FIG. 3 shows a schematic representation of non-volatile memory media 300a (e.g. computer/compact disc (CD) or digital versatile disc (DVD)) and 300b (e.g. universal serial bus (USB) memory stick) storing instructions and/or parameters 302 which when executed by a processor allows the processor to perform one or more of the steps of the methods described herein.

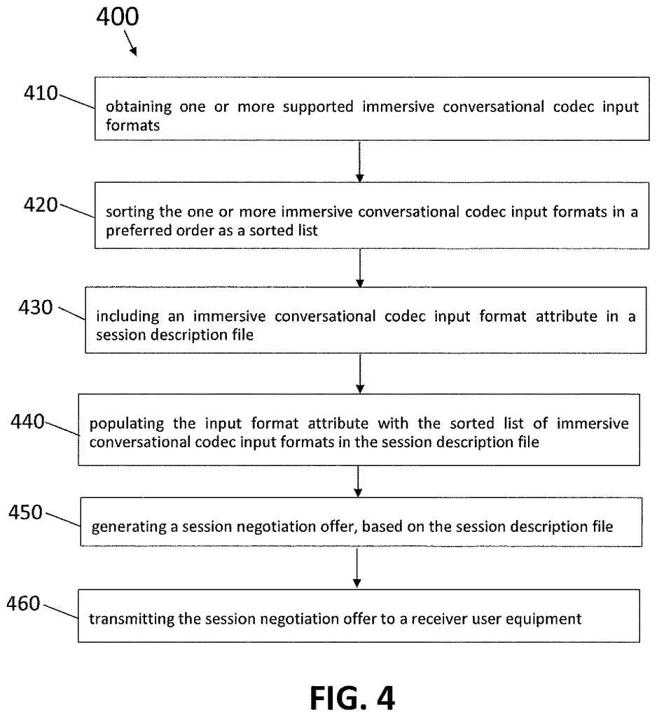

FIG. 4 is an example method 400 performed by a sender, based on the example embodiments described herein. At 410, the method includes obtaining one or more supported immersive conversational codec input formats. At 420, the method includes sorting the one or more immersive conversational codec input formats in a preferred order as a sorted list. At 430, the method includes including an immersive conversational codec input format attribute in a session description file. At 440, the method includes populating the input format attribute with the sorted list of immersive conversational codec input formats in the session description file. At 450, the method includes generating a session negotiation offer, based on the session description file. At 460, the method includes transmitting the session negotiation offer to a receiver user equipment. Method 400 may be performed with a sending apparatus, such as UE 110, UE1 610-1, UE2 610-2, or apparatus 200.

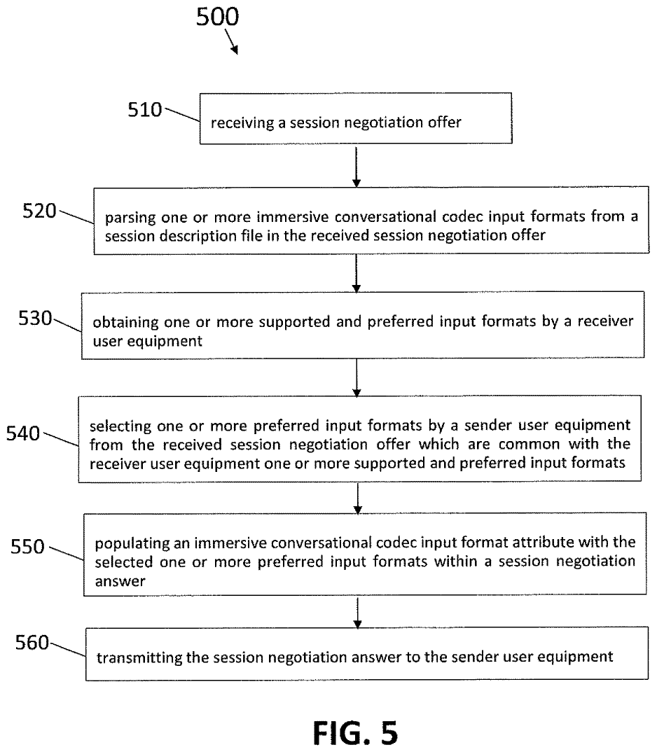

FIG. 5 is an example method 500 performed by a receiver, based on the example embodiments described herein. At 510, the method includes receiving a session negotiation offer. At 520, the method includes parsing one or more immersive conversational codec input formats from a session description file in the received session negotiation offer. At 530, the method includes obtaining one or more supported and preferred input formats by a receiver user equipment. At 540, the method includes selecting one or more preferred input formats by a sender user equipment from the received session negotiation offer which are common with the receiver user equipment one or more supported and preferred input formats. At 550, the method includes populating an immersive conversational codec input format attribute with the selected one or more preferred input formats within a session negotiation answer. At 560, the method includes transmitting the session negotiation answer to the sender user equipment. Method 500 may be performed with a receiving apparatus, such as UE 110, UE1 610-1, UE2 610-2, or apparatus 200.

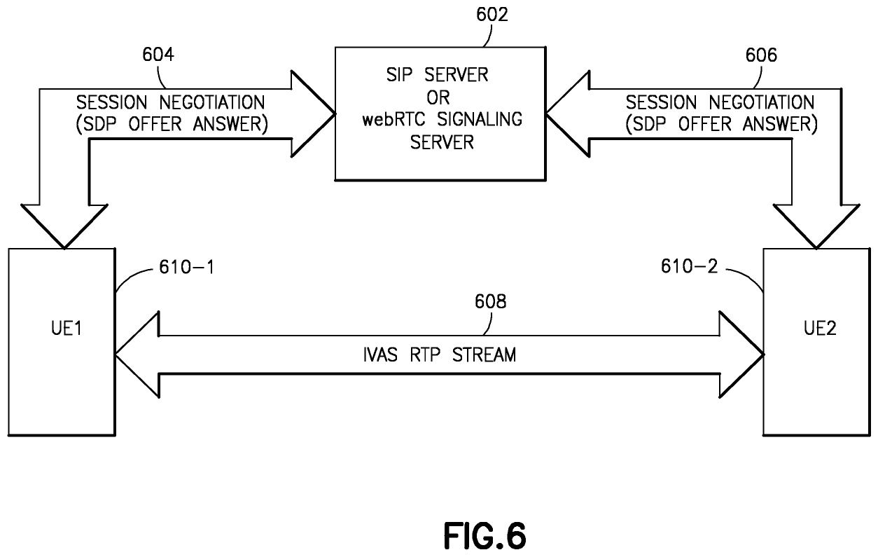

FIG. 6 shows an example of a conversational immersive audio session between two participants, UE1 610-1 and UE2 610-2. The two UEs can negotiate (604, 606) an immersive conversational session via a suitable session negotiation mechanism over SIP/SDP or via SDP offer answer using another signaling protocol. Based on the UE capabilities and preferences, the session offer is delivered from UE1 to UE2 via SDP offer. The answer is provided by UE2 as SDP answer. As a consequence of agreed session negotiation, RTP media delivery carrying an IVAS bitstream (608) as payload is initiated among the two UEs (610-1, 610-2). SIP server or webRTC signaling server (602) facilitates the session negotiation (604, 606).

The following examples (1-32) are provided and described herein in addition to Examples 1-7 above describing offer answer negotiation scenarios.

Example 1. An apparatus including: at least one processor; and at least one memory storing instructions that, when executed by the at least one processor, causes the apparatus at least to: obtain one or more supported immersive conversational codec input formats; sort the one or more immersive conversational codec input formats in a preferred order as a sorted list; include an immersive conversational codec input format attribute in a session description file; populate the input format attribute with the sorted list of immersive conversational codec input formats in the session description file; generate a session negotiation offer, based on the session description file; and transmit the session negotiation offer to a receiver user equipment.

Example 2. The apparatus of example 1, wherein the session description file comprises an input format indication, an output format indication, and format switching for bitrate adaptation as an attribute or media format parameter.

Example 3. The apparatus of any of examples 1 to 2, wherein the session negotiation offer is represented as a session description protocol (SDP) file.

Example 4. The apparatus of any of examples 1 to 3, wherein the transmitting of the session negotiation offer is performed as a session description offer answer model.

Example 5. The apparatus of any of examples 1 to 4, wherein the instructions, when executed by the at least one processor, causes the apparatus at least to: receive a session negotiation answer from the receiver user equipment; constrain a bitrate adaptation of a sender user equipment to a single input format, when the session negotiation answer comprises a single input format.

Example 6. The apparatus of any of examples 1 to 5, wherein the instructions, when executed by the at least one processor, causes the apparatus at least to: receive a session negotiation answer from the receiver user equipment; constrain a bitrate adaptation of a sender user equipment to a single input format, when the session negotiation answer explicitly disables input format switching.

Example 7. The apparatus of example 6, wherein the input format switching is explicitly disabled with use of a disable input format switching session description protocol (SDP) parameter.

Example 8. The apparatus of example 7, wherein the disable input format switching SDP parameter comprises disable-inf-switch.

Example 9. The apparatus of any of examples 1 to 8, wherein the instructions, when executed by the at least one processor, causes the apparatus at least to: receive a session negotiation answer from the receiver user equipment; wherein a bitrate adaptation of a sender user equipment is flexible to utilize any of one or more agreed input formats, when the session negotiation answer comprises two or more input formats.

Example 10. The apparatus of any of examples 1 to 9, wherein a codec format is indicated as an immersive voice and audio codec (IVAS) for the session negotiation offer with a bitstream constrained to immersive conversational audio codec bitstreams, and the session negotiation offer does not include an enhanced voice codec (EVS) bitstream for rate adaptation.

Example 11. The apparatus of any of examples 1 to 10, wherein an input format is included as a media format parameter or as an attribute in the session description file with a corresponding codec parameter being an immersive voice and audio codec parameter.

Example 12. The apparatus of any of examples 1 to 11, wherein the one or more immersive conversational codec input formats are sorted based on encoding computational complexity.

Example 13. The apparatus of any of examples 1 to 12, wherein the one or more immersive conversational codec input formats are sorted based on at least one audio capture capability of a sender user equipment.

Example 14. An apparatus including: at least one processor; and at least one memory storing instructions that, when executed by the at least one processor, causes the apparatus at least to: receive a session negotiation offer; parse one or more immersive conversational codec input formats from a session description file in the received session negotiation offer; obtain one or more supported and preferred input formats by a receiver user equipment; select one or more preferred input formats by a sender user equipment from the received session negotiation offer which are common with the receiver user equipment one or more supported and preferred input formats; populate an immersive conversational codec input format attribute with the selected one or more preferred input formats within a session negotiation answer; and transmit the session negotiation answer to the sender user equipment.

Example 15. The apparatus of example 14, wherein the session description file comprises an input format indication, an output format indication, and format switching for bitrate adaptation as an attribute or media format parameter.

Example 16. The apparatus of any of examples 14 to 15, wherein the session negotiation offer is represented as a session description protocol (SDP) file, and the session negotiation answer is represented as an SDP file.

Example 17. The apparatus of any of examples 14 to 16, wherein the receiving of the session negotiation offer is performed as a session description offer answer model, and the transmitting of the session negotiation answer is performed as a session description offer answer model.

Example 18. The apparatus of any of examples 14 to 17, wherein a bitrate adaptation of the sender user equipment is constrained to a single input format, when the session negotiation answer comprises a single input format.

Example 19. The apparatus of any of examples 14 to 18, wherein a bitrate adaptation of a sender user equipment is constrained to a single input format, when the session negotiation answer explicitly disables input format switching.

Example 20. The apparatus of example 19, wherein the input format switching is explicitly disabled with use of a disable input format switching session description protocol (SDP) parameter.

Example 21. The apparatus of example 20, wherein the disable input format switching SDP parameter comprises disable-inf-switch.

Example 22. The apparatus of any of examples 14 to 21, wherein a bitrate adaptation of the sender user equipment is flexible to utilize any of one or more agreed input formats, when the session negotiation answer comprises two or more input formats.

Example 23. The apparatus of any of examples 14 to 22, wherein a codec format is indicated as an immersive voice and audio codec (IVAS) for the session negotiation offer and session negotiation answer with a bitstream constrained to immersive conversational audio codec bitstreams, and the session negotiation offer and session negotiation answer do not include an enhanced voice codec (EVS) bitstream for rate adaptation.

Example 24. The apparatus of any of examples 14 to 23, wherein an input format is included as a media format parameter or as an attribute in the session description file with a corresponding codec parameter being an immersive voice and audio codec parameter.

Example 25. The apparatus of any of examples 14 to 24, wherein the one or more immersive conversational codec input formats are sorted based on encoding computational complexity.

Example 26. The apparatus of any of examples 14 to 25, wherein the one or more immersive conversational codec input formats are sorted based on at least one audio capture capability of the sender user equipment.

Example 27. A method including: obtaining one or more supported immersive conversational codec input formats; sorting the one or more immersive conversational codec input formats in a preferred order as a sorted list; including an immersive conversational codec input format attribute in a session description file; populating the input format attribute with the sorted list of immersive conversational codec input formats in the session description file; generating a session negotiation offer, based on the session description file; and transmitting the session negotiation offer to a receiver user equipment.

Example 28. A method including: receiving a session negotiation offer; parsing one or more immersive conversational codec input formats from a session description file in the received session negotiation offer; obtaining one or more supported and preferred input formats by a receiver user equipment; selecting one or more preferred input formats by a sender user equipment from the received session negotiation offer which are common with the receiver user equipment one or more supported and preferred input formats; populating an immersive conversational codec input format attribute with the selected one or more preferred input formats within a session negotiation answer; and transmitting the session negotiation answer to the sender user equipment.

Example 29. An apparatus including: means for obtaining one or more supported immersive conversational codec input formats; means for sorting the one or more immersive conversational codec input formats in a preferred order as a sorted list; means for including an immersive conversational codec input format attribute in a session description file; means for populating the input format attribute with the sorted list of immersive conversational codec input formats in the session description file; means for generating a session negotiation offer, based on the session description file; and means for transmitting the session negotiation offer to a receiver user equipment.

Example 30. An apparatus including: means for receiving a session negotiation offer; means for parsing one or more immersive conversational codec input formats from a session description file in the received session negotiation offer; means for obtaining one or more supported and preferred input formats by a receiver user equipment; means for selecting one or more preferred input formats by a sender user equipment from the received session negotiation offer which are common with the receiver user equipment one or more supported and preferred input formats; means for populating an immersive conversational codec input format attribute with the selected one or more preferred input formats within a session negotiation answer; and means for transmitting the session negotiation answer to the sender user equipment.

Example 31. A non-transitory program storage device readable by a machine, tangibly embodying a program of instructions executable by the machine for performing operations, the operations including: obtaining one or more supported immersive conversational codec input formats; sorting the one or more immersive conversational codec input formats in a preferred order as a sorted list; including an immersive conversational codec input format attribute in a session description file; populating the input format attribute with the sorted list of immersive conversational codec input formats in the session description file; generating a session negotiation offer, based on the session description file; and transmitting the session negotiation offer to a receiver user equipment.

Example 32. A non-transitory program storage device readable by a machine, tangibly embodying a program of instructions executable by the machine for performing operations, the operations including: receiving a session negotiation offer; parsing one or more immersive conversational codec input formats from a session description file in the received session negotiation offer; obtaining one or more supported and preferred input formats by a receiver user equipment; selecting one or more preferred input formats by a sender user equipment from the received session negotiation offer which are common with the receiver user equipment one or more supported and preferred input formats; populating an immersive conversational codec input format attribute with the selected one or more preferred input formats within a session negotiation answer; and transmitting the session negotiation answer to the sender user equipment.

References to a ‘computer’, ‘processor’, etc. should be understood to encompass not only computers having different architectures such as single/multi-processor architectures and sequential/parallel architectures but also specialized circuits such as field-programmable gate arrays (FPGAs), application specific circuits (ASICs), signal processing devices and other processing circuitry. References to computer program, instructions, code etc. should be understood to encompass software for a programmable processor or firmware such as, for example, the programmable content of a hardware device such as instructions for a processor, or configuration settings for a fixed-function device, gate array or programmable logic device, etc.

As used herein, the term ‘circuitry’, ‘circuit’ and variants may refer to any of the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and one or more memories that work together to cause an apparatus to perform various functions, and (c) circuits, such as a microprocessor(s) or a portion of a microprocessor(s), that require software or firmware for operation, even if the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device. Circuitry or circuit may also be used to mean a function or a process used to execute a method.

It should be understood that the foregoing description is only illustrative. Various alternatives and modifications may be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

The following acronyms and abbreviations that may be found in the specification and/or the drawing figures are defined as follows:
3GPP 3rd generation partnership project
4G fourth generation of broadband cellular network technology
5G fifth generation cellular network technology
5GC 5G core network
AMF access and mobility management function
AMR-WB IO adaptive multi rate wideband inter-operable
ASIC application specific integrated circuit
AVP audio-video protocol
BRIR binaural room impulse response
CD compact/computer disc
CPU central processing unit
CR carriage return
CU central unit or centralized unit
DCT discrete cosine transform
DL downlink
DSP digital signal processor
DU distributed unit
DVD digital versatile disc
eNB evolved Node B (e.g., an LTE base station)
EN-DC E-UTRAN new radio-dual connectivity
en-gNB node providing NR user plane and control plane protocol terminations towards the UE, and acting as a secondary node in EN-DC
E-UTRA evolved universal terrestrial radio access, i.e., the LTE radio access technology
E-UTRAN E-UTRA network
EVS enhanced voice services
F1 interface between the CU and the DU
FOA first-order ambisonics
FPGA field programmable gate array
gNB base station for 5G/NR, i.e., a node providing NR user plane and control plane protocol terminations towards the UE, and connected via the NG interface to the 5GC
H.2xx family of video coding standards in the domain of the ITU-T (e.g. H.264)
H.323 standard defining the protocols to provide audio-visual communication sessions on a packet network
HEVC high efficiency video coding
HOA higher order ambisonics
HOA2 2^{nd} order higher-order ambisonics
HOA3 3rd order higher-order ambisonics
HRIR head-related impulse response
IAB integrated access and backhaul
IANA Internet Assigned Numbers Authority
I/F interface
IMS instant messaging service
I/O input/output
IP internet protocol
IPv4 internet protocol version 4
ISM independent streams with metadata (i.e., type of object-based audio)
ITU International Telecommunication Union
ITU-T ITU Telecommunication Standardization Sector
IVAS immersive voice and audio services
kbps kilobits per second
L16 uncompressed audio data using a 16-bit signed representation
LF line feed
LMF location management function
LTE long-term evolution
MAC medium access control
MASA metadata-assisted spatial audio
MC multichannel
MME mobility management entity
MRO mobility robustness optimization
ng or NG new generation
ng-eNB new generation eNB
NG-RAN new generation radio access network
NR new radio
NTP network time protocol
N/W network
OMASA object-based audio with MASA (combined input format)
PCMU pulse code modulation using μ-law
PDA personal digital assistant
PDCP packet data convergence protocol
PHY physical layer
PT payload type
QoS quality of service
RAN radio access network
RAM random access memory
RFC request for comments
RLC radio link control
ROM read only memory
RRC radio resource control
RTCP real-time transport control protocol
RTP real-time transport protocol
RTSP real time streaming protocol
RU radio unit
Rx receiver
SBA scene-based audio
SDP session description protocol
SGW serving gateway
SIP session initiation protocol
SMF session management function
SON self-organizing/optimizing network
Tdoc technical document
TRP transmission reception point
TS technical specification
TTL time to live
Tx transmitter
UAV unmanned aerial vehicle
UCS universal character set
UDP user datagram protocol
UE user equipment
UI user interface
UMTS universal mobile telecommunications system
UPF user plane function
URI uniform resource identifier
USB universal serial bus
UTF-8 UCS transformation format 8
UTRAN UMTS terrestrial radio access network
VoLTE voice over LTE
VR virtual reality
WebRTC or webRTC web real-time communication
X2 network interface between RAN nodes and between RAN and the core network
Xn network interface between NG-RAN nodes

1. An apparatus, comprising:
at least one processor; and
at least one memory storing instructions that, when executed with the at least one processor, cause the apparatus at least to:
obtain one or more supported immersive conversational codec input formats;
provide the one or more immersive conversational codec input formats in a preferred order as a list;
include an immersive conversational codec input format attribute in a session description file;
populate the input format attribute with the list of immersive conversational codec input formats in the session description file;
generate a session negotiation offer, based on the session description file; and
transmit the session negotiation offer to a receiver user equipment.

2. The apparatus as claimed in claim 1, wherein the session description file comprises an input format indication, an output format indication, and format switching for bitrate adaptation as an attribute or media format parameter.

3. The apparatus as claimed in claim 1, wherein the session negotiation offer is represented as a session description protocol file.

4. The apparatus as claimed in claim 1, wherein the transmitting of the session negotiation offer is performed as a session description offer answer model.

5. The apparatus as claimed in claim 2, wherein the instructions, when executed with the at least one processor, cause the apparatus at least to:
receive a session negotiation answer from the receiver user equipment; and
constrain the bitrate adaptation of a sender user equipment to a single input format, when the session negotiation answer comprises at least one of:
a single input format; or
explicitly disabled input format switching.

6. (canceled)

7. The apparatus of as claimed in claim 5, wherein the input format switching is explicitly disabled with use of a disable input format switching session description protocol parameter.

8. The apparatus as claimed in claim 2, wherein the instructions, when executed with the at least one processor, cause the apparatus at least to:
receive a session negotiation answer from the receiver user equipment, wherein a bitrate adaptation of a sender user equipment is flexible to utilize any of one or more agreed input formats, when the session negotiation answer comprises two or more input formats.

9. The apparatus as claimed in claim 1, wherein a codec format is indicated as an immersive voice and audio codec for the session negotiation offer with a bitstream constrained to immersive conversational audio codec bitstreams, and the session negotiation offer does not include an enhanced voice codec bitstream for rate adaptation.

10. The apparatus as claimed in claim 1, wherein an input format is included as a media format parameter or as an attribute in the session description file with a corresponding codec parameter being an immersive voice and audio codec parameter.

11. The apparatus as claimed in claim 1, wherein the one or more immersive conversational codec input format is provided in the preferred order as the list based on at least one of:
encoding computational complexity; or
at least one audio capture capability of a sender user equipment.

12. (canceled)

13. An apparatus, comprising:
at least one processor; and
at least one memory storing instructions that, when executed with the at least one processor, cause the apparatus at least to:
receive a session negotiation offer;
parse one or more immersive conversational codec input formats from a session description file in the received session negotiation offer;
obtain one or more supported and preferred input formats with a receiver user equipment;
select one or more preferred input formats with a sender user equipment from the received session negotiation offer which are common with the receiver user equipment one or more supported and preferred input formats;
populate an immersive conversational codec input format attribute with the selected one or more preferred input formats within a session negotiation answer; and
transmit the session negotiation answer to the sender user equipment.

14. The apparatus as claimed in claim 13, wherein the session description file comprises an input format indication, an output format indication, and format switching for bitrate adaptation as an attribute or media format parameter.

15. The apparatus as claimed in claim 13, wherein the session negotiation offer is at least one of:
represented as a session description protocol file, and the session negotiation answer is represented as a session description protocol file, or
performed as a session description offer answer model, and the transmitting of the session negotiation answer is performed as the session description offer answer model.

16. (canceled)

17. The apparatus as claimed in claim 13, wherein the bitrate adaptation of the sender user equipment is at least one of:
flexible to utilize any of one or more agreed input formats, when the session negotiation answer comprises two or more input formats; or
constrained to a single input format, when the session negotiation answer comprises at least one of:
a single input format; or
explicitly disabled input format switching.

18-21. (canceled)

22. The apparatus as claimed in claim 13, wherein an input format is included as a media format parameter or as an attribute in the session description file with a corresponding codec parameter being an immersive voice and audio codec parameter.

23. The apparatus as claimed in claim 13, wherein the one or more immersive conversational codec input formats is provided in the preferred order as the list based on at least one of:
encoding computational complexity; or
at least one audio capture capability of the sender user equipment.

24. (canceled)

25. A method, comprising:
obtaining one or more supported immersive conversational codec input formats;
providing the one or more immersive conversational codec input formats in a preferred order as a list;
including an immersive conversational codec input format attribute in a session description file;
populating the input format attribute with the list of immersive conversational codec input formats in the session description file;
generating a session negotiation offer, based on the session description file; and
transmitting the session negotiation offer to a receiver user equipment.

26. A method, comprising:
receiving a session negotiation offer;
parsing one or more immersive conversational codec input formats from a session description file in the received session negotiation offer;
obtaining one or more supported and preferred input formats with a receiver user equipment;
selecting one or more preferred input formats with a sender user equipment from the received session negotiation offer which are common with the receiver user equipment one or more supported and preferred input formats;
populating an immersive conversational codec input format attribute with the selected one or more preferred input formats within a session negotiation answer; and
transmitting the session negotiation answer to the sender user equipment.

27-30. (canceled)

31. The apparatus as claimed in claim 17, wherein the input format switching is explicitly disabled with use of a disable input format switching session description protocol parameter.

32. The apparatus as claimed in claim 13, wherein a codec format is indicated as an immersive voice and audio codec for the session negotiation offer and the session negotiation answer with a bitstream constrained to immersive conversational audio codec bitstreams, and the session negotiation offer and the session negotiation answer do not include an enhanced voice codec bitstream for rate adaptation.
